(19) United States
(12) Patent Application Publication
(10) Pub. No.: US 2004/0107083 A1
(43) Pub. Date: Jun. 3, 2004

(54) System, method and computer product for predicting biological pathways

(76) Inventors: Joshua Michael Temkin, Clifton Park, NY (US); Brion Daryl Sarachan, Schenectady, NY (US); Seth Aaron Grossman, Guilderland, NY (US); Ming Zhao, Clifton Park, NY (US); Mark Richard Gilder, Clifton Park, NY (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/307,556

(22) Filed: Dec. 2, 2002

(51) Int. Cl. G06G 7/48; G06G 7/58

(52) U.S. Cl. 703/11

(57) ABSTRACT

System, method and computer product for predicting biological pathways. In this disclosure, a data extraction module automatically extracts biological data from biological data sources. A pathway database contains the extracted biological data. A pathway analysis module assimilates the biological data into a hypotheses prediction for generating a pathway. A visualization module generates a visual representation of the pathway generated by the pathway analysis module.

### BACKGROUND OF THE INVENTION

This disclosure relates generally to bioinformatics and more particularly to predicting biological pathways from biologic data stored in disparate biological data sources.

Biological pathways may be considered as a combination of Metabolic Pathways, Signal Transduction Pathways and perhaps others. Prior to the completion of the human genome project, researchers generally attempted to discover pathways in a wet lab environment. Researching pathways in a wet lab environment typically begins after discovering a new protein. Once a new protein has been discovered, researchers run assays and protein gels to separate various proteins involved in formation of the new protein. The researchers then classify each protein individually and build experiments designed to inhibit production of one or more of the proteins expressed in the gel. The researchers derive the pathway through a series of inhibition experiments and classification experiments of the expressed proteins. A drawback associated with developing pathways in the wet lab environment is that it generally takes years to develop and classify each individual protein expressed in a pathway.

Developing pathways has changed in light of the large amount of data generated from the human genome project and other projects that involve understanding disease mechanisms and additional cellular processes. Instead of using the wet lab environment to exclusively develop pathways, pieces of the pathways (e.g., proteins, protein expressions, protein interactions, protein functional information, protein structures, etc.) are found in publications generated as a result of the above-noted projects. To develop a pathway from the many pieces of biologic data, researchers have to manually search through public databases containing the publications and try to find data in the vast amount of literature that can be linked and correlated. If the researchers are successful, they can generate hypothetical models representing pathways. The researchers then can build experiments that test the hypotheses embodied in the hypothetical models. This approach to developing pathways is time consuming and researchers typically have to continually perform updated searches in order to ensure that all relevant data to a particular pathway is captured.

Researchers have contemplated using automated search tools to overcome some of the problems associated with developing a pathway from a manual search of public databases. A problem associated with using automated search tools in the hypothesis generation of pathways is that currently available computing techniques are unable to efficiently organize biological data (e.g., proteins, protein expressions, protein interactions, protein functional information, protein structures, etc.) stored in the many different public databases with useful annotations that advance pathway development. A reason that it is difficult to efficiently organize the biological data with useful annotations is that the databases each have their own unique schema and approach of representing pathways and biological data. For example, some databases focus primarily on protein-protein interactions, while other databases contain other information such as the direction of interactions and annotations that describe interacting proteins in a textual format. Another problem is that inconsistencies exist in the naming conventions used to represent protein and genomic names in each of the databases. Consequently, querying and associating the large amounts of data across these sources with currently available computing techniques is difficult and becomes more complex as the amount of biologic data generated increases.

Therefore, there is a need for an approach that can automatically generate hypothesis prediction of new pathways from the large amount of biologic data stored in databases having different schemas and approaches to representing, the data.

### BRIEF DESCRIPTION OF THE INVENTION

In a first embodiment of this disclosure, there is a system for building a biological pathway. In this embodiment, there is a data extraction module that automatically extracts biological data from a plurality of biological data sources. A pathway database contains the extracted biological data. A pathway analysis module assimilates the biological data into a hypotheses prediction for generating a pathway. A visualization module generates a visual representation of the pathway generated by the pathway analysis module.

In another embodiment of this disclosure, there is a system for building a biological pathway. In this embodiment, there is a plurality of biological data sources each containing biological data. A data extraction module automatically extracts biological data from the plurality of biological data sources. A pathway database contains the extracted biological data and a pathway analysis module assimilates the biological data into a hypotheses prediction for generating a pathway. A visualization module generates a visual representation of the pathway generated by the pathway analysis module.

In a third embodiment of this disclosure, there is a method and computer readable medium that stores instructions for instructing a computer system, to build a biological pathway. This embodiment comprises automatically extracting biological data from a plurality of biological data sources; storing the extracted biological data; assimilating the biological data into a hypotheses prediction for generating a pathway; and generating a visual representation of the pathway using the hypotheses prediction.

### BRIEF DESCRIPTION OF THE DRAWINGS

FIG. 1 shows a schematic of a general-purpose computer system in which a system that automates hypothesis generation of new pathways operates;

FIG. 2 shows a high level architecture diagram of a system that automates hypothesis generation of new pathways, which operates on the computer system shown in FIG. 1;

FIG. 3 shows a schematic of the schema of the pathway database shown in FIG. 2;

FIG. 4 shows an example of a pathway diagram generated from the system shown in FIG. 2;

FIG. 5 shows the system of FIG. 2 in communication with a plurality of biological data sources;

FIG. 6 shows an architectural diagram of a system for implementing the system shown in FIGS. 2 and 5 on a network;

FIG. 7 shows a more detailed view of the data extraction module shown in FIGS. 2 and 5;

FIG. 8 shows a more detailed view of a spider shown in FIG. 7;

FIG. 9 shows an alternative implementation of the spider shown in FIG. 7; and

FIG. 10 shows a flow chart describing the operations performed by the data extraction module.

### DETAILED DESCRIPTION OF THE INVENTION

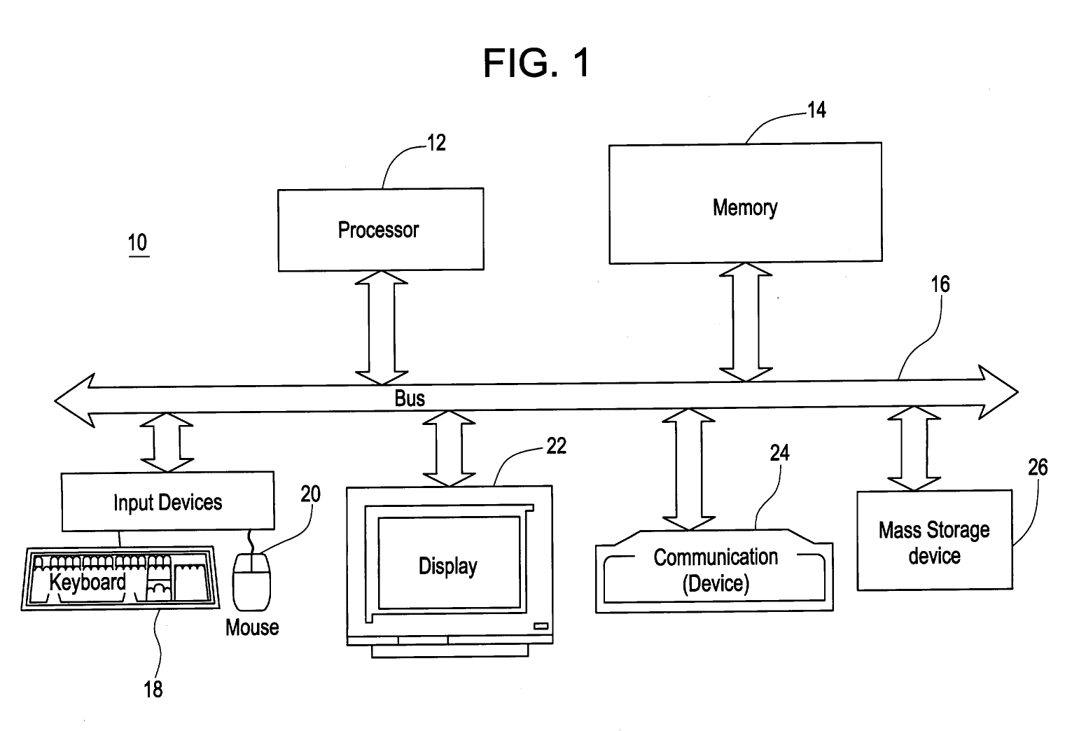

FIG. 1 shows a schematic of a general-purpose computer system 10 in which a system that automates hypothesis generation of new pathways operates. The computer system 10 generally comprises at least one processor 12, a memory 14, input/output devices, and a bus 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices may comprise a keyboard 18 and a mouse 20 that enter data and instructions into the computer system 10. Also, a display 22 may be used to allow a user to see what the computer has accomplished. Other output devices may include a printer, plotter, synthesizer, speakers, and other devices. A communication device 24 such as a telephone or cable modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN, a wide area network (WAN) or the Internet. A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer or supercomputer.

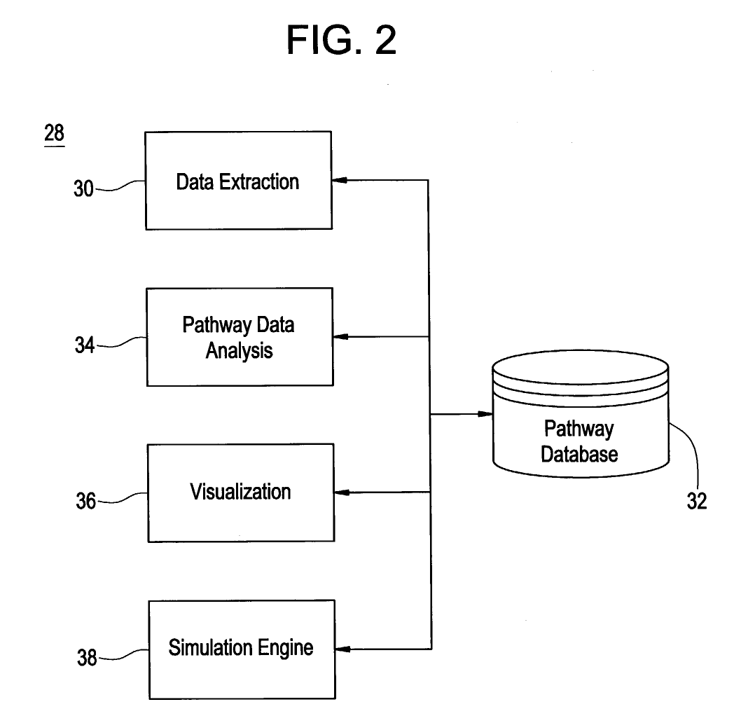

FIG. 2 shows a high level architecture diagram of a system 28 that automates hypothesis generation of new pathways, which operates on the computer system 10 shown in FIG. 1. The pathway hypothesis generation system 28 comprises a data extraction module 30 that automatically extracts biological data from a plurality of biological data sources. Biological data may include: Bioinformatics data, (i.e., data relating to gathering, analyzing, and representing genes and proteins, along with their structure and function, and correlating these to disease and population variations), Medical informatics data (i.e., data relating to gathering, analyzing, and representing longitudinal patient studies in health and disease while providing decision support or predictive tools to assist in the diagnosis and prognosis of clinical patient care) and other data. An illustrative, but non-exhaustive list of biological data sources include databases such as Pronet, BIND, Transpath, Swiss Prot and Pubmed. The data extraction module 30 comprises an Internet-based automated agent (e.g., a spider) that automatically extracts the biological data from the data sources. An Internet-based automated agent or spider is a computer program that automatically retrieves data such as Web pages from the World Wide Web. The spider may retrieve biological data such as protein interactions from protein interactive databases such as Pronet, BIND and Transpath; annotated protein sequences from a protein knowledgebase such as Swiss Prot; and textual information on proteins such as publications from PubMed.

A pathway database 32 stores the biological data retrieved by the data extraction module 30. In addition to the protein interactions, annotated protein sequences and textual information retrieved from the Pronet, BIND, Transpath, Swiss Prot, and PubMed databases. The pathway database 32 may store other data from these databases. For example, the BIND database provides other data with the protein interactions such as molecule short names, molecules types, species, experimental conditions and publication links. In addition to protein interaction data, Transpath includes molecule short names, synonyms, molecule full names, molecule classes and publication links. In addition to annotated protein sequences, Swiss Prot includes molecule short names, synonyms, molecule full names, species, homologs, publication references, amino acid sequences, molecular weights, lengths, tissue specificities and locations. Beside publications, PubMed includes other information such as full text abstracts, molecule short names, molecule full names, synonyms and interactions. All of this data, as well as other data, is capable of being extracted and stored in the pathway database 32.

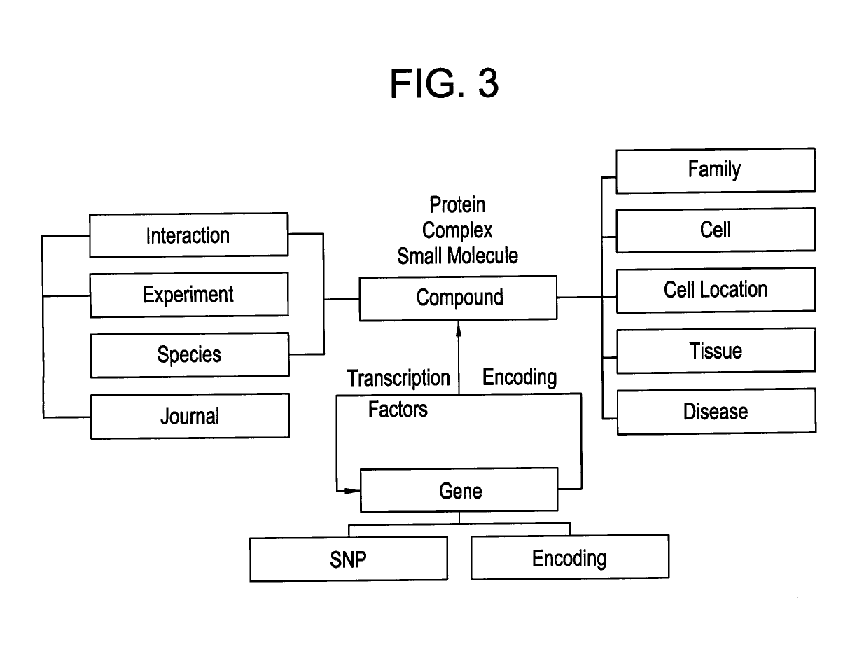

The pathway database 32 is an object-oriented database, however, one of ordinary skill in the art will recognize that the pathway database may be a relational database. FIG. 3 shows a schematic of the schema of the pathway database 32.

As shown in FIG. 3, the schema implemented by pathway database 32 is a universal schema and data representation capable of storing genes, proteins, and protein interaction data housed in a single database representing the superset of information available in structured public data sources such as those discussed above. Information that is gathered and mined from these and other public data sources using automated software parsers (e.g., spiders) may be normalized and merged into the universal schema shown in FIG. 3. Proteomic and interaction data records that are present in more than one of the disparate sources may be merged together into single records in pathway database 32. The merger of these intersecting data records allows, among other things, for larger, more complete representations of protein interaction networks. The combined mined data from these sources has proven to be an important advantage in building dynamic representations of biological pathways, as no single public database contains all the interactions known or published concerning any given single protein or compound.

Referring again to FIG. 2, the pathway generation system 28 also comprises a pathway data analysis module 34 that assimilates the biological data stored in the pathway database 32 into a hypotheses prediction for generating a pathway. In particular, the pathway data analysis module 34 may use clustering algorithms to perform sequence and interaction clustering. For example, pathway data analysis module 34 may comprise clustering algorithms that group functionally or sequence related items (e.g., genes, proteins, etc.) into related sets or clusters. Once grouped into clusters, data analysis module 34 may examine similarities within or between clusters and predict other pathways that may be similar. In addition to clustering, the pathway data analysis module 34 uses filters to mine the biological data stored in the pathway database 32. Other data analysis techniques may also be used.

A visualization module 36 generates a visual representation of the pathway generated by the pathway data analysis module 34. For example, visualization module 36 may enable a set of integrated visualization and mapping algorithms to draw the associated data into viewable annotated representations of biological pathways. Users of the system may view the data (e.g., through a graphical interface (GUI)) that displays proteins of interest as nodes in a directed network, and interactions between the proteins as directed edges showing pathways as cascades of interacting proteins. In addition, edges are annotated as described and mined from the various public data sources.

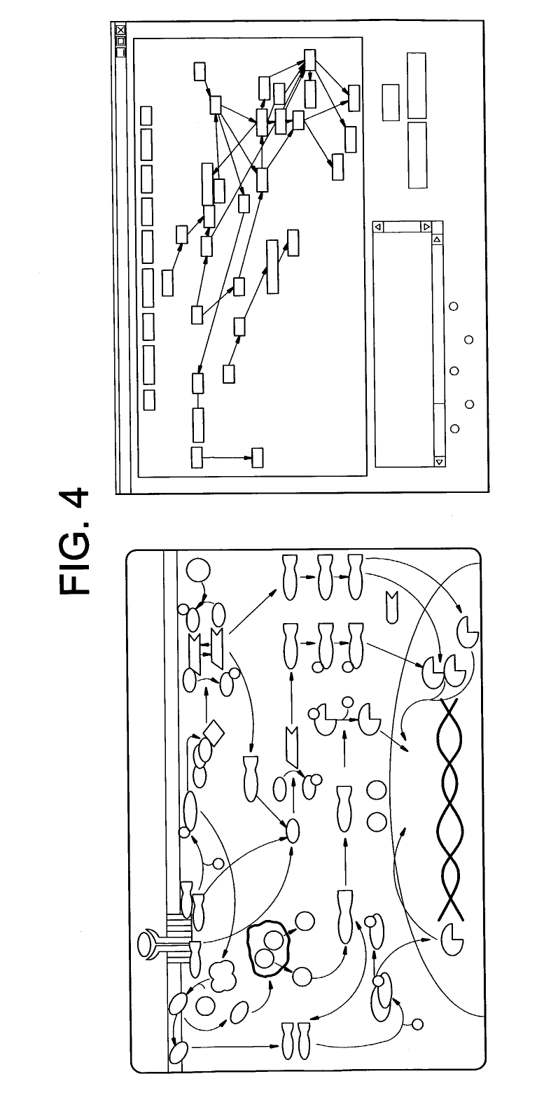

FIG. 4 shows an example of a pathway diagram generated from the visualization module 36. In particular, FIG. 4 shows a pathway diagram and protein interaction map of a T-Cell Recptor. The pathway diagram shown in FIG. 4 comprises a set of nodes representing biological entities with lines connecting the nodes to each other. A biological entity is a particular or discrete unit that is part of, plays a role in, or affects a biological system. Biological entities include any components of a biological system or any objects, elements or molecules that affect biological function. For example, a biological entity may comprise a gene, protein, peptide, oligonucleotide, molecule, cell or any variable affecting a biological system. According to some embodiments, a line pointing from a first node to a second node indicates that the entity represented by the first node influences or affects the entity represented by the second node in some capacity. Other graphical techniques are also possible.

Referring again to FIG. 2, the pathway generation system 28 also may comprise a simulation engine 38 that enables, among other things, generation of pathways based upon prediction and other data. In some embodiments, simulation engine 38 may comprise an interface to an external simulation engine. Other functions and types of simulation engines are possible.

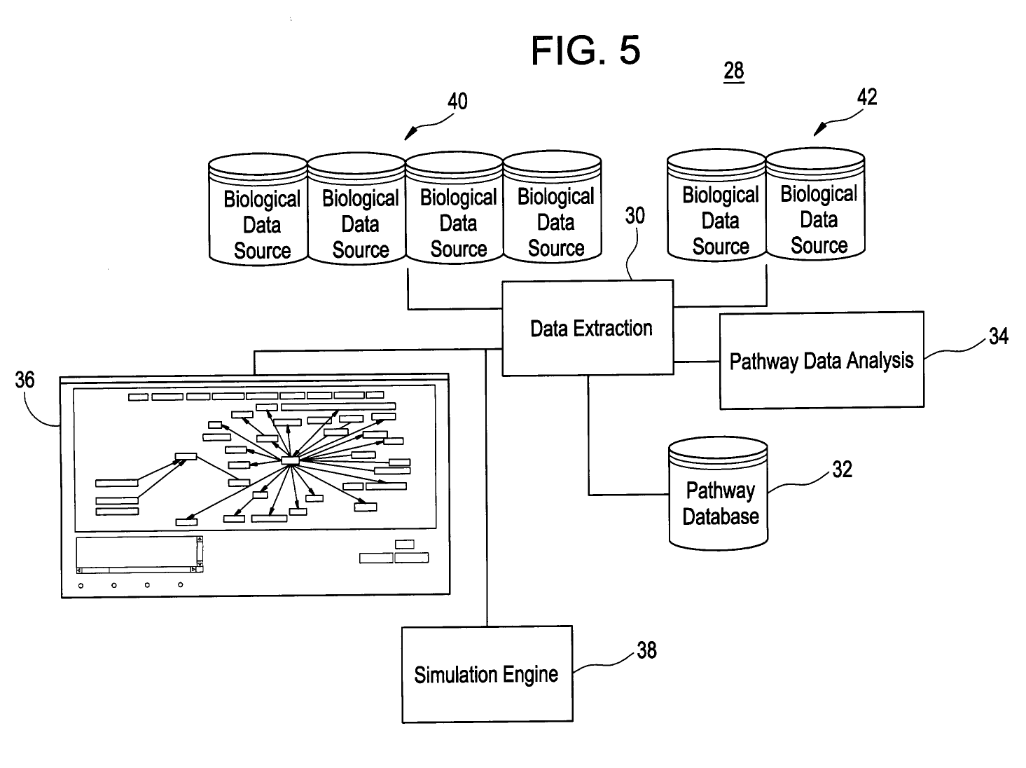

FIG. 5 shows the pathway generation system 28 of FIG. 2 in communication with a plurality of biological data sources 40 and 42. In FIG. 5, the biological data sources 40 contain data such as protein interaction data and biological data sources 42 contain data such as textual information on proteins and protein sequences. As mentioned above, examples of protein interactive data sources are Pronet, BIND and Transpath and examples of data sources containing textual information on proteins are Swiss Prot and PubMed. This disclosure is not limited to the Pronet, BIND, Transpath, Swiss Prot and PubMed databases. One of ordinary skill in the art will recognize that other biological data sources 40 and 42 may be accessed. For example, one of ordinary skill in the art can retrieve protein interaction data from other interaction databases such as Biocarta, BRENDA, BRITE, DIP, PIM, MINT, etc. Also, one of ordinary skill in the art will recognize that other signal transduction pathway databases can be used in addition to or in place of Transpath such as SPAD, KEGG, etc. Also, one of ordinary skill in the art will recognize that other annotated protein sequence databases can be used in addition to or in place of Swiss Prot such as MIPS, EBI, etc. One of ordinary skill in the art will also recognize that other textual information databases can be used in addition to or in place of PubMed such as Medline.

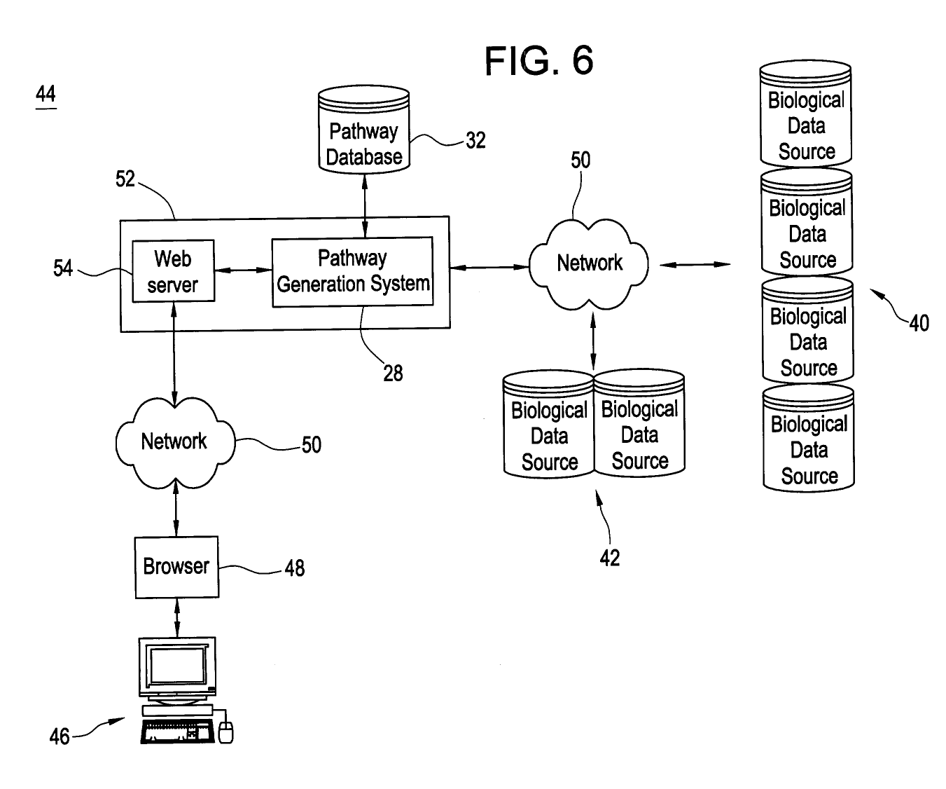

FIG. 6 shows an architectural diagram of a system 44 for implementing the pathway generation system 28 shown in FIGS. 2 and 5 on a network. In FIG. 6, a computing unit 46 allows a user to access the pathway generation system 28 including the pathway database 32 and the biological data sources 40 and 42 over a network such as the Internet. The computing unit 46 can take the form of a hand-held digital computer, personal digital assistant computer, notebook computer, personal computer or workstation. The user uses a web browser 48 such as Microsoft INTERNET EXPLORER,™ Netscape NAVIGATORTM or Mosaic to locate, display and use the pathway generation system 28 and the biological data sources 40 and 42 on the computing unit 46. A communication network 50 such as an electronic or wireless network connects the computing unit 46 to the pathway generation system 28 including the pathway database 32 and the biological data sources 40 and 42. In particular, the computing unit 46 may connect to the pathway generation system 28 and pathway database 32 through a private network such as an extranet or intranet or a global network such as a WAN (e.g., the Internet). As shown in FIG. 6, the pathway generation system 28 may reside in a server 52, which comprises a web server 54 that serves the pathway generation system 28, pathway database 32 and the data from the biological data sources 40 and 42. One of ordinary skill in the art will recognize that pathway generation system 28 does not have to be co-resident with the server 52. In addition, pathway generation system 28 may be distributed over more than one server or other configuration of networked devices.

If desired, the system 44 may have functionality that enables authentication and access control of users accessing the pathway generation system 28 and pathway database 32. Both authentication and access control can be handled at the web server level by the pathway generation system 28 itself, or by commercially available packages such as Netegrity SITEMINDER. Information to enable authentication and access control such as the user's name, location, telephone number, organization, login identification, password, access privileges to certain resources, physical devices in the network, services available to physical devices, etc. can be retained in a database directory. The database directory can take the form of a lightweight directory access protocol (LDAP) database; however, other directory type databases with other types of schema may be used including relational databases, object-oriented databases, flat files, or other data management systems.

In this implementation, the pathway generation system 28 may run on the web server 54 in the form of servlets, which are applets (e.g., Java applets) that run a server. Alternatively, the pathway generation system 28 may run on the web server 54 in the form of CGI (Common Gateway Interface) programs. The servlets access the pathway database 32 and biological data sources 40 and 42 using JDBC or Java database connectivity, which is a Java application programming interface that enables Java programs to execute SQL (structured query language) statements. Alternatively, the servlets may access the pathway database 32 and biological data sources 40 and 42 using ODBC or open database connectivity. Using hypertext transfer protocol or HTTP, the web browser 48 obtains a variety of applets that execute the pathway generation system 28 on the computing unit 46 allowing the user to perform processing operations discussed below. Also, the web browser may be used to view Web pages containing biological data and access analysis tools, plotting tools, graphics programs, etc.

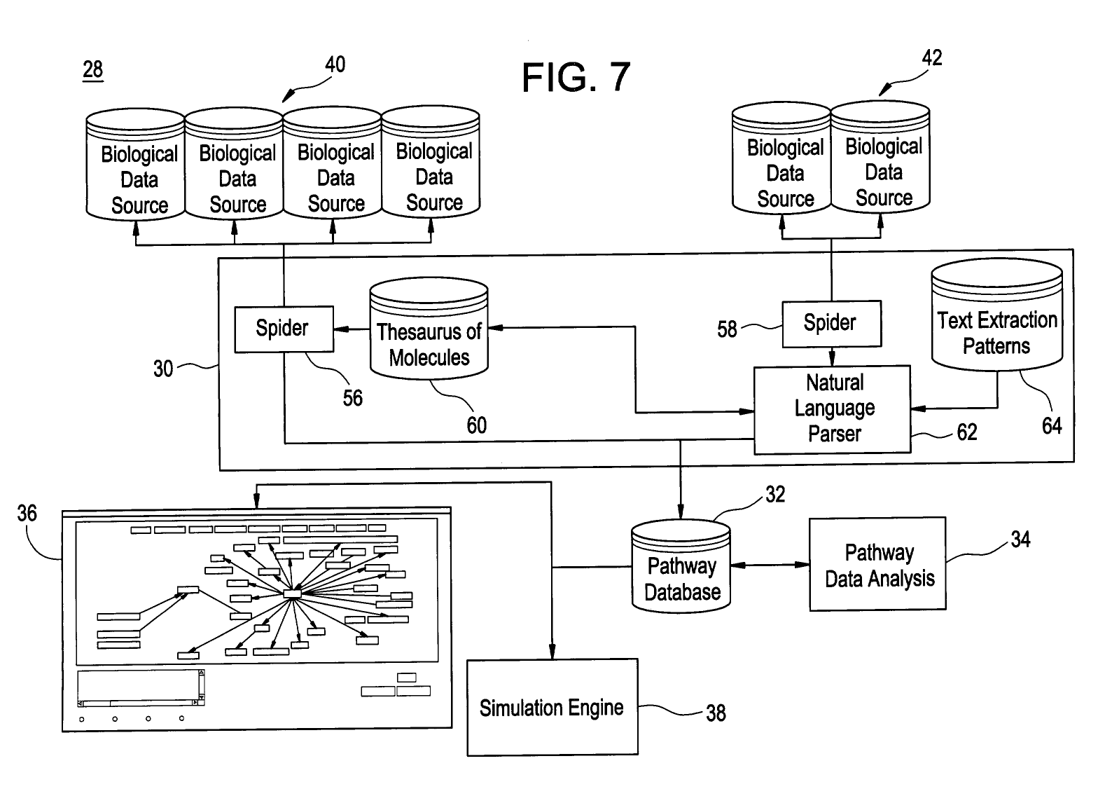

FIG. 7 shows a more detailed view of the data extraction module 30 in relation to the other elements shown in FIG. 5. The data extraction module 30 comprises spiders 56 and 58 that automatically extract the biological data from the data sources 40 and 42, respectively. FIG. 7 shows that there are two spiders, one for extracting data from the protein interactive databases 40 and another for extracting data from the textual-based databases 42. One of ordinary skill in the art will recognize that other implementations are possible such as having one spider to extract data from all of the data sources or a separate spider for each individual data source. A thesaurus of molecules 60 assists the spider 56 in extracting protein interactions from the data sources 40. The thesaurus of molecules 60 contains a collection of synonyms for known molecules. Using the collection of synonyms in the thesaurus 60 as a reference, the spider 56 goes to each of the data sources 40 and finds as many protein interactions as possible that match a desired molecule name. The spider 56 then places the retrieved interactions in the pathway database 32.

The spider 58 is similar to the spider 56, except that it uses a natural language parser 62 because the data sources 42 contain textual information. The natural language parser 62 analyzes the whole structure of the sentences retrieved by the spider 58 from the data sources 42 and extracts relationships from the articles and abstracts. In this disclosure, the natural language parser 62 uses a database of text extraction patterns 64 to assist in extracting relationships from the retrieved articles and abstracts. The natural language parser 62 operates by making multiple passes of the retrieved articles and abstracts and reducing the text to a set of tagged words. The thesaurus of molecules 60 also assists the natural language parser 62 in the tagging of words. An illustrative, but non-exhaustive list of tags made by the natural language parser 62 include protein and peptide names (short and long), molecule names (short and long), disease names (short and long), experiment names (short and long), cell names (short and long), action words (interaction keywords) and negators. As an example, the natural language parser 62 may tag the molecule lectin-like oxidized low density lipoprotein as the long name and LOX-1 as the short name.

The natural language parser 62 uses the tags to extract interactions between molecules. In particular, the natural language parser 62 examines the tags that relate to molecules and cell names and looks for other tags that indicate relationships between the molecules and cell names. Tags that indicate relationships between molecules and cell names include action words (interaction keywords) and negators such as “does not inhibit”, “inhibits,” etc. Below is an example of how the natural language parser 62 parses a sentence received from the spider 58. The sentence in this example is:

“IL-10 inhibits the synthesis of a number of cytokines, including IFN-GAMMA, IL-2, IL-3, TNF and GM-CSF.”

For this sentence, the natural language parser 62 tags IL-10, IFN-GAMMA, IL-2, IL-3, TNF and GM-CSF as short name molecules. The natural language parser 62 also tags “inhibit” as an interaction keyword. The natural language parser 62 then extracts the following interactions:

IL-10 inhibits IFN-GAMMA;

WL-10 inhibits IL-2;

IL-10 inhibits IL-3;

IL-10 inhibits TNF; and

IL-10 inhibits GM-CSF.

The natural language parser 62 then places the extracted interactions in the pathway database 32.

Below is an example of how the natural language parser 62 would process an abstract stored in the data source 40. The abstract in this example is:

IL-18 (0-100 ng/ml) specifically upregulated ICAM-1 expression on monocytes in human PBMC as demonstrated in our previous study. In the present study, we examined whether the synergistic upregulation of ICAM-1 occurred after the stimulation with the combination of IL-18 and IL-12 and whether the synergistic production of IFN-gamma was dependent on the interaction between ICAM-1 on monocytes and LFA-1 on NK/T cells. The effect of IL-12 on ICAM-1 expression on monocytes was marginal even at the highest concentration (100 ng/ml). However, in the presence of IL-12 (100 ng/ml), the expression of ICAM-1 induced by IL-18 was significantly enhanced as compared with that obtained by IL-18 alone. In addition to the expression of ICAM-1 on monocytes, IFN-gamma production was synergistically stimulated by IL-18 and IL-12. Anti-ICAM-1 and anti-LFA-1 Abs exhibited significant inhibitory effect on enhanced production of IFN-gamma by the combination of two cytokines, in particular, anti-ICAM-1 showing the complete inhibition. These results as a whole indicated that synergistic effect of IL-18 and IL-12 on IFN-gamma production in human PBMC is ascribed to the synergism of the effect of two cytokines on ICAM-1 expression on monocytes and that the subsequent ICAM-1/LFA-1 interaction plays an important role in the enhanced production of IFN-gamma.

The natural language parser 62 tags the above abstract as follows:

IL-18 (0-100 ng/ml) specifically upregulated ICAM-1 expression on monocytes in human PBMC as demonstrated in our previous study. In the present study, we examined whether the synergistic upregulation of ICAM-1 occurred after the stimulation with the combination of IL-18 and IL-12 and whether the synergistic production of IFN-gamma was dependent on the interaction between ICAM-1 on monocytes and LFA-1 on NK/T cells. The effect of IL-12 on ICAM-1 expression on monocytes was marginal even at the highest concentration (100 ng/ml). However, in the presence of IL-12 (100 ng/ml), the expression of ICAM-1 induced by IL-18 was significantly enhanced as compared with that obtained by IL-18 alone. In addition to the expression of ICAM-1 on monocytes, IFN-gamma production was synergistically stimulated by IL-18 and IL-12. Anti-ICAM-1 and anti-LFA-1 Abs exhibited significant inhibitory effect on enhanced production of IFN-gamma by the combination of two cytokines, in particular, anti-ICAM-1 showing the complete inhibition. These results as a whole indicated that synergistic effect of IL-18 and IL-12 on IFN-gamma production in human PBMC is ascribed to the synergism of the effect of two cytokines on ICAM-1 expression on monocytes and that the subsequent ICAM-1/LFA-1 interaction plays an important role in the enhanced production of IFN-gamma.

The natural language parser 62 then extracts the following information:

Molecules in Abstract

IL-18

ICAM-1

IL-12

IFN-Gamma

LFA-1

Anti-ICAM-1

Anti-LFA-1

Interactions

IL-18 upregulates ICAM-1

II-12+II18 induced ICAM1 more than IL-18 alone

IFN-gamma production increased by L-18 and IL-12

ICAM1/ILFA1 role in IFN-Gamma Production

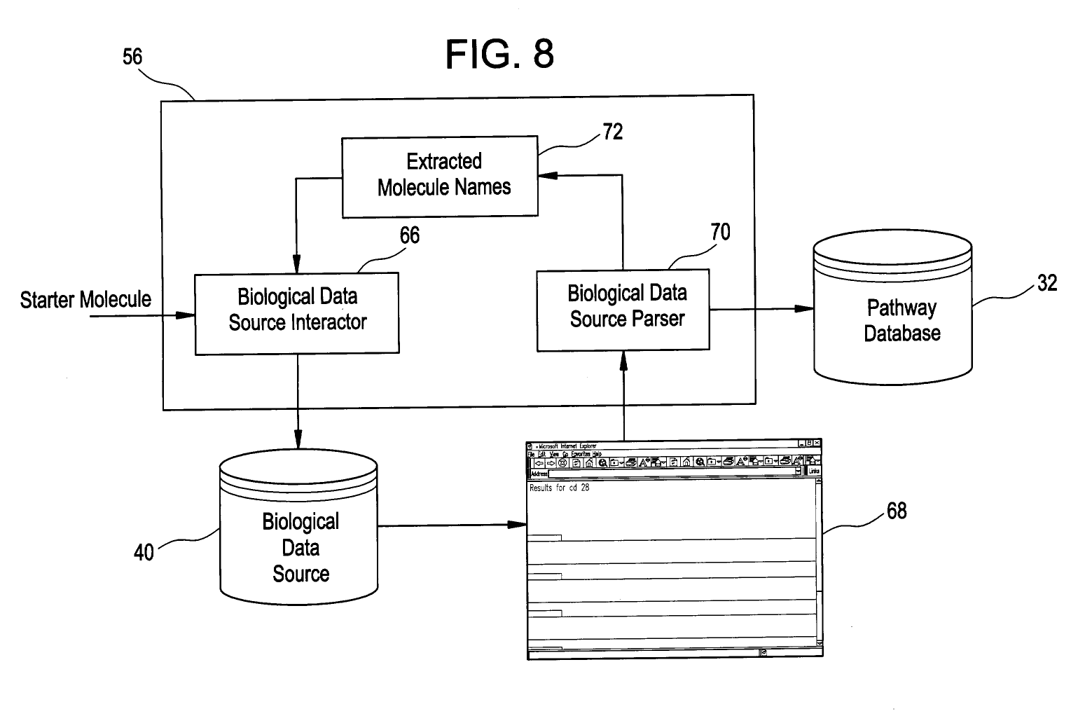

FIG. 8 shows a more detailed view of the spider 56 used in the data extraction module 30 of FIG. 7. The spider comprises a data source interactor 66 that queries a biological data source 40 for particular molecules. The results of the query performed by the data source interactor 66 are shown in FIG. 8 as a Web page 68. A data source parser 70 using the thesaurus of molecules 60 (shown in FIG. 7) extracts molecule names 72 from the results and stores them in the pathway database 32. In addition, the data source interactor 66 receives the extracted molecule names, which are shown in FIG. 8 as reference 72.

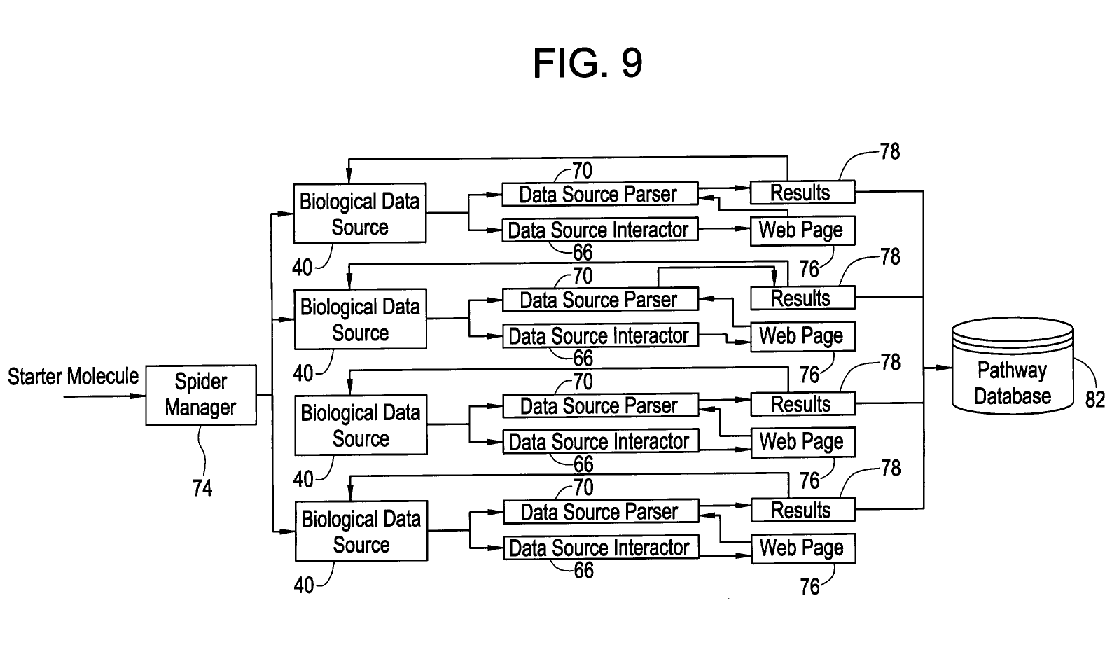

FIG. 9 shows a schematic of the spider 56 implemented to extract data from multiple data sources. In this implementation, the spider comprises a spider manager 74 that manages each of the data source interactors 66 and data source parsers 70 allocated for a specified data source 40 and 42. Each data source interactor 66 receives a Web page 76 of the results returned from the data source 40 or 42. The data source parsers 70 then extract the molecule names or results 78 from the Web pages 76 using the thesaurus of molecules. The results are then stored in the pathway database 32. In some embodiments, the results may be fed back into each respective data source.

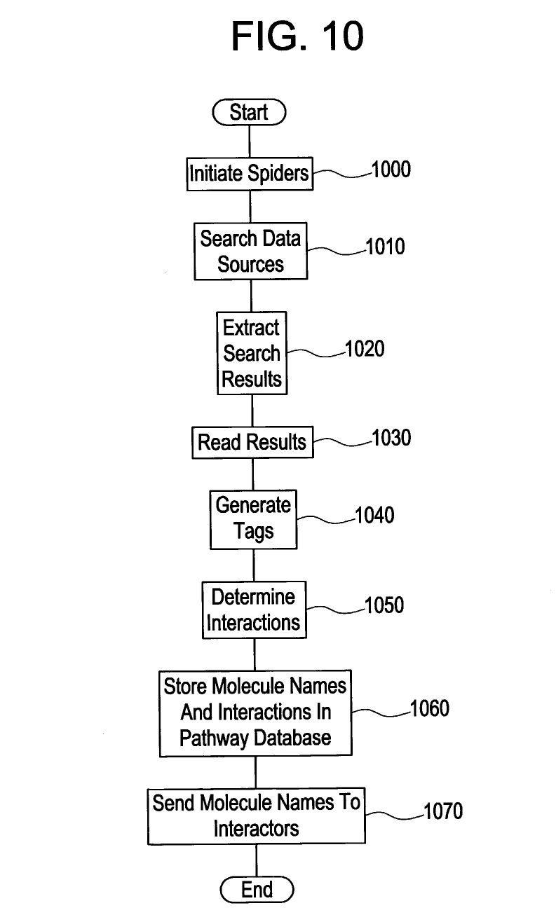

FIG. 10 shows a flow chart describing the operations performed by the data extraction module. At 1000, the data extraction module initiates the spiders to search the data sources for a specified molecule. Upon initiation, the data source interactors begin searching each of their respective data sources for the specified molecule at 1010. The data extraction module then extracts the results from the data sources at 1020. The results are then ready for processing by each of the data source parsers. In particular, each of the data source parsers reads the results at 1030 and generates a set of tags at 1040 using the thesaurus of molecules or database of text extraction patterns. The data source parsers then determine the interactions between each of the tags at 1050 such as the relationships between molecules, proteins, genes and cells. The data source parsers then store the names and relationships between molecules, proteins, genes and cells in the pathway database at 1060. In addition, the data source parser sends the extracted molecule names to the data source interactor at 1070.

The foregoing figures show one embodiment of the functionality and operation of the system. In this regard, some of the blocks represent a module, component, segment, or portion of code, which comprises one or more executable instructions for implementing the specified logical function(s). It should also be noted that in some alternative implementations, the functions noted in the blocks may occur out of the order noted in the figure or, for example, may in fact be executed substantially concurrently or in the reverse order, depending upon the functionality involved. Furthermore, the functions can be implemented in programming languages such as Java, however, other languages can also be used.

The above-described systems comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

The computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided a system, method and computer product for predicting biological pathways. While the invention has been particularly shown and described in conjunction with a preferred embodiment thereof, it will be appreciated that variations and modifications can be effected by a person of ordinary skill in the art without departing from the scope of the invention.

What is claimed is:

1. A system for elucidating a biological pathway, comprising:
a data extraction module that automatically extracts biological data from a plurality of biological data sources;
a pathway database containing the extracted biological data;
a pathway analysis module that assimilates the biological data into a hypotheses prediction for generating a pathway; and
a visualization module that generates a visual representation of the pathway generated by the pathway analysis module.

2. The system according to claim 1, wherein the data extraction module comprises a spider that automatically extracts the biological data from the plurality of biological data sources.

3. The system according to claim 2, wherein the spider comprises a data source interactor that queries each of the plurality of biological data sources for biological data and a data source parser that parses retrieved biological data.

4. The system according to claim 2, wherein the spider comprises a natural language parser that removes text-based patterns from biological data sources that contain textual information.

5. The system according to claim 4, wherein the natural language parser determines relationships between the biological data extracted from the biological data sources.

6. The system according to claim 5, wherein the natural language parser generates a summary of biological data extracted from the biological data sources and any interactions between the data.

7. The system according to claim 2, wherein the spider comprises a manager that manages a plurality of data source interactors that each query a specified biological data source for biological data and a plurality of data source parsers that each parse biological data retrieved from a specified biological data source.

8. The system according to claim 1, wherein the pathway analysis module comprises a clustering module that performs sequence and interaction clustering.

9. The system according to claim 1, wherein the visualization module comprises a mapping module to draw the associated data into viewable annotated representations of biological pathways.

10. The system according to claim 1, further comprising a simulation engine that enables generation of pathways based upon prediction and other data.

11. A system for predicting a biological pathway, comprising:
a plurality of biological data sources each containing biological data;
a data extraction module that automatically extracts biological data from the plurality of biological data sources;
a pathway database containing the extracted biological data;
a pathway analysis module that assimilates the biological data into a hypotheses prediction for generating a pathway; and
a visualization module that generates a visual representation of the pathway generated by the pathway analysis module.

12. The system according to claim 11, wherein the data extraction module comprises a spider that automatically extracts the biological data from the plurality of biological data sources.

13. The system according to claim 12, wherein the spider comprises a data source interactor that queries each of the plurality of biological data sources for biological data and a data source parser that parses retrieved biological data.

14. The system according to claim 12, wherein the spider comprises a natural language parser that removes text-based patterns from the biological data sources that contain biological publications.

15. The system according to claim 14, wherein the natural language parser determines relationships between the biological data extracted from the biological data sources.

16. The system according to claim 15, wherein the natural language parser generates a summary of biological data extracted from the biological data sources and any interactions between the data.

17. The system according to claim 12, wherein the spider comprises a manager that manages a plurality of data source interactors that each query a specified biological data source for biological data and a plurality of data source parsers that each parse biological data retrieved from a specified biological data source.

18. The system according to claim 11, wherein the pathway analysis module comprises a clustering module that performs sequence and interaction clustering.

19. The system according to claim 11, wherein the visualization module comprises a mapping module to draw the associated data into viewable annotated representations of biological pathways.

20. The system according to claim 11, further comprising a simulation engine that enables generation of pathways based upon prediction and other data.

21. A method for building a biological pathway, comprising:
automatically extracting biological data from a plurality of biological data sources;
storing the extracted biological data;
assimilating the biological data into a hypotheses prediction for generating a pathway; and
generating a visual representation of the pathway using the hypotheses prediction.

22. The method according to claim 21, wherein the extraction of biological data comprises querying each of the plurality of biological data sources for biological data and parsing the retrieved biological data.

23. The method according to claim 21, wherein the extraction of biological data comprises removing text-based patterns from biological data sources that contain biological publications.

24. The method according to claim 23, further comprising determining relationships between the biological data extracted from the biological data sources.

25. The method according to claim 24, further comprising generating a summary of biological data extracted from the biological data sources and any interactions between the data.

26. The method according to claim 21, wherein the extraction of biological data comprises using a plurality of data source interactors to query a specified biological data source for biological data and a plurality of data source parsers to parse biological data retrieved from a specified biological data source into a suitable format.

27. The method according to claim 21, wherein assimilating the biological data further comprises performing sequence and interaction clustering.

28. The method according to claim 21, wherein generating a visual representation comprises mapping the associated data into viewable annotated representations of biological pathways.

29. The method according to claim 21, further comprising simulating generation of pathways based upon prediction and other data.

30. A computer-readable medium storing computer instructions for instructing a computer system to build a biological pathway, the computer instructions comprising:
automatically extracting biological data from a plurality of biological data sources;
storing the extracted biological data;
assimilating the biological data into a hypotheses prediction for generating a pathway; and
generating a visual representation of the pathway using the hypotheses prediction.

31. The computer-readable medium according to claim 30, wherein the extraction of biological data comprises instructions for querying each of the plurality of biological data sources for biological data and parsing the retrieved biological data.

32. The computer-readable medium according to claim 30, wherein the extraction of biological data comprises instructions for removing text-based patterns from biological data sources that contain biological publications.

33. The computer-readable medium according to claim 32, further comprising instructions for determining relationships between the biological data extracted from the biological data sources.

34. The computer-readable medium according to claim 33, further comprising instructions for generating a summary of biological data extracted from the biological data sources and any interactions between the data.

35. The computer-readable medium according to claim 30, wherein the extraction of biological data comprises instructions for using a plurality of data source interactors to query a specified biological data source for biological data and a plurality of data source parsers to parse biological data retrieved from a specified biological data source.

36. The computer-readable medium according to claim 30, wherein assimilating the biological data further comprises instructions for performing sequence and interaction clustering.

37. The computer-readable medium according to claim 30, wherein generating a visual representation comprises instructions for mapping the associated data into viewable annotated representations of biological pathways.

38. The computer-readable medium according to claim 30, further comprising simulating generation of pathways based upon prediction and other data.
